(19) United States
(12) Patent Application Publication
(10) Pub. No.: US 2022/0326752 A1
(43) Pub. Date: Oct. 13, 2022

(54) Multiprotocol USB Adaptive Charging

(71) Applicant: Microchip Technology Incorporated, Chandler, AZ (US)

(72) Inventors: Venkataraman Krishnamoorthy, Chennai (IN); Atish Ghosh, Austin, TX (US); Riyas Kattukandan, Palakkad (IN); Poornima Raviselvan, Redhills (IN)

(73) Assignee: Microchip Technology Incorporated, Chandler, AZ (US)

(21) Appl. No.: 17/548,795

(22) Filed: Dec. 13, 2021

Related U.S. Application Data
(60) Provisional application No. 63/172,147, filed on Apr. 8, 2021.

(51) Int. Cl. G06F 1/26; G06F 13/42

(52) U.S. Cl. CPC G06F 1/266; G06F 13/4282; G06F 2213/0042

(57) ABSTRACT

A system includes a power source, a universal serial bus (USB) type C port, and a multi-protocol adaptive circuit. The multi-protocol adaptive circuit may be configured to determine that a USB element has attached to the USB type C port, to determine whether to apply a USB type C charging protocol to the USB element or a legacy USB type A charging protocol to the USB element, and to provide power from the power source to the USB element.

### PRIORITY

This application claims priority to U.S. Provisional Patent Application No. 63/172,147 filed Apr. 8, 2021, the contents of which are hereby incorporated in their entirety.

### FIELD OF THE INVENTION

The present disclosure relates to universal serial bus (USB) power and communication and, more particularly, to multiprotocol USB adaptive charging.

### BACKGROUND

Before the protocol definition for USB Type C connections added specifications for power delivery (PD) for battery charging, various implementations of USB were used that included modes of battery charging. These implementations may be specific to particular manufacturers or regions. For example, battery charging (BC) 1.0 and 1.1 were developed by the USB Implementers Forum (USB-IF); Omega developed 1.0 A, 1.5 A, 2.5 A, and Omega 3 A charging modes (herein referred to variously as Omega mode); a charging protocol was specified by Chinese Telecommunications Industry Standard YD/T 1591-2009 (herein referred to as China mode); Samsung developed a charging mode (herein referred to as Samsung mode); and Blackberry developed a charging mode (herein referred to as Blackberry mode). Nevertheless, these have been superseded now by a new BC 1.2 Specification. A compliance test suite by USB IF for BC1.2 specifically mandates that the device only is compliant BC1.2 standards only. Moreover, USB Type C may include or not include PD on a given connection.

Inventors of examples of the present disclosure have discovered that this proliferation of different standards causes difficulty in providing the correct charging protocol for USB devices. Moreover, inventors of examples of the present disclosure have discovered that the proliferation of different standards is further complicated by the ability of USB Type A devices to be connected to a USB Type C port through an adapter. Examples of the present disclosure may address one or more of these challenges.

### BRIEF DESCRIPTION OF THE DRAWINGS

FIG. 1 is an illustration of an example system for multiprotocol adaptive charging, according to examples of the present disclosure.

FIG. 2 is a more detailed illustration of ports, according to examples of the present disclosure.

FIG. 3 is an illustration of an example method for determining whether a USB element has attached to a USB Type A port or a USB Type C port, according to examples of the present disclosure.

FIG. 4 is an illustration of an example method for determining how to power a USB element that has attached to a USB Type A port, according to examples of the present disclosure.

FIGS. 5-6 are an illustration of an example method for selecting a best available battery charging solution from available or known protocols to apply to an attached USB element, according to examples of the present disclosure.

FIG. 7 is an illustration of an example method for determining how to power a USB element that has attached to a USB Type C port, according to examples of the present disclosure.

### DETAILED DESCRIPTION

Examples of the present disclosure may include an apparatus. The apparatus may include any suitable number and kind of USB ports. For example, the apparatus may include a USB type C port. The apparatus may include a multi-protocol adaptive circuit configured to determine that a USB element has attached to the USB type C port, and to determine whether to apply a USB type C charging protocol to the USB element or a legacy USB type A charging protocol to the USB element. The multi-protocol adaptive circuit may be implemented in any suitable manner, such as by analog circuitry, digital circuitry, instructions on a machine-readable medium for execution by a processor, an application specific integrated circuit, a field programmable gate array, or any suitable combination thereof. The multi-protocol adaptive circuit may be configured to determine, for example, whether the USB element is a legacy USB type A charging element that has connected to the USB type C port through an adapter.

In combination with any of the above examples, the multi-protocol adaptive circuit may be further configured to, in order to determine whether to apply a USB type C charging protocol or a legacy USB type A charging protocol to the USB element, send source capabilities to the USB element, evaluate a reaction of the USB element in response to the sent source capabilities, and determine whether to apply a USB type C charging protocol or a legacy USB type A charging protocol to the USB element based upon the reaction. For example, if no reply is received, the multi-protocol adaptive circuit may be configured to handle the USB element as a USB type A element that has connected to the USB type C port through an adapter. If a reply is received, the multi-protocol adaptive circuit may be configured to handle the USB element as a USB type C element.

Thus, in combination with any of the above examples, the multi-protocol adaptive circuit may be further configured to determine to apply a legacy USB type A charging protocol to the USB element based upon the reaction of the USB element, the reaction to include no reply.

In combination with any of the above examples, the multi-protocol adaptive circuit may be further configured to determine that the USB element is a USB type A element connected through an adapter to the USB type C port. This may be determined based upon the no reply to the sending of source capabilities.

In combination with any of the above examples, the multi-protocol adaptive circuit may be further configured to apply a legacy USB type A charging protocol or a battery charging 1.2 protocol mode to the USB element based upon the determination that the USB element is a USB type A element connected through the adapter to the adapter to the USB type C port. The legacy USB type A charging protocols may include, for example, Omega charging mode, China charging mode, Samsung charging mode, or Blackberry charging mode.

In combination with any of the above examples, the multi-protocol adaptive circuit may be further configured to, upon a determination that a legacy USB type A charging protocol is to be applied to the USB element, apply a series of a plurality of candidate legacy USB type A charging protocols to the USB element to determine a best protocol among the candidate legacy USB type A charging protocols to be used by the USB element. These legacy USB type A charging protocols may include, for example, Omega charging mode, China charging mode, Samsung charging mode, or Blackberry charging mode. Battery charging 1.0, 1.1, 1.2, or other standardized USB specified protocols may be applied if the candidate legacy USB type A charging protocols are not matched to the USB element.

In combination with any of the above examples, the multi-protocol adaptive circuit may be further configured to apply the series of candidate legacy USB type A charging protocols through, for each candidate legacy USB type A charging protocol, application of test voltages to a D+ line and a D− line connected between the USB type C port and the USB element. The test voltages may be associated with the candidate legacy USB type A charging protocol. The series of candidate legacy USB type A charging protocols may be ordered according to charging power.

In combination with any of the above examples, the multi-protocol adaptive circuit may be further configured to, based upon a determination that the USB element has applied a pull-up resistor in response to the test voltages, determine that a China mode legacy USB type A charging protocol is be used by the USB element.

Examples of the present disclosure may include systems including any of the above apparatuses and a power source, wherein the multi-protocol adaptive circuit is configured to cause powering the USB element from the power source according to a selected USB charging protocol.

Examples of the present disclosure may include methods performed by any of the above apparatuses or systems.

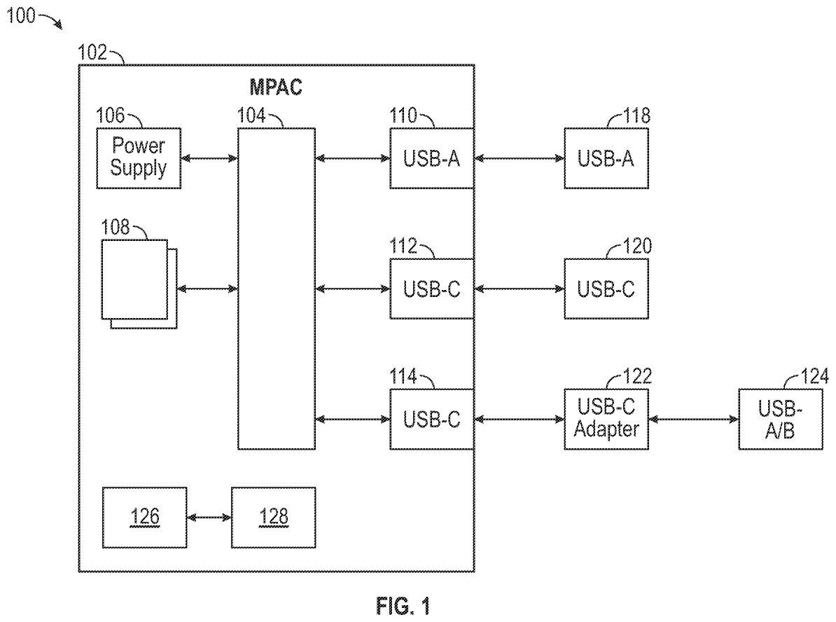

FIG. 1 is an illustration of an example system 100 for multiprotocol adaptive charging (MPAC), according to examples of the present disclosure.

System 100 may include an MPAC device 102. MPAC device 102 may be implemented as part of any larger system, such as a computer, infotainment system, head unit, server, charger, hub, bridge, or any other suitable electronic device. MPAC device 102 may be configured to accept connections to one or more USB elements, and to charge such elements. Such elements may include, for example, USB devices, USB hosts, USB adapters, or USB devices or hosts connected through USB adapters. The USB elements may be implemented using, for example, USB Type C hosts or devices, USB Type A hosts or devices, USB Type C—USB 2 Micro B adapters, USB Type C—USB 2 Mini B adapters, USB Type C—USB 3 Micro B adapters, Type C—USB 3 Mini B adapters, and Type C—Type A adaptors. The protocols that MPAC device 102 may be configured to use when communicating and powering these USB elements may include, for example, the battery charging (BC) Specification such as BC 1.2 Specification, Type C with power delivery (PD) (wherein up to 20 V and 100 W may be supported), or Type C without PD (wherein up to 5 V may be supported). Moreover, MPAC device 102 may be configured to comply with USB Implementer's Forum (IF) test suites.

MPAC device 102 may include ports 110, 112, 114. Although three such ports are shown, any suitable number, kind, and combination of ports may be used. Port 110 may be a USB Type A port. Port 112 may be a USB Type C port. Port 114 may be a USB Type C port. Any suitable USB element may attach to port 110, such as device 118, which may be a USB Type A type device or host. Any suitable USB element may attach to port 112, such as device 120, which may be a USB Type C device or host. Any suitable USB element may attach to port 114, such as adapter 122, which may be a USB Type C adapter for converting other USB protocols or connectors to USB Type C. Any suitable USB element may be connected to MPAC device 102 through adapter 122, such as USB element 124. USB element 124 may be, for example, a USB Type A or USB Type B device or host.

MPAC device 102 may be implemented in any suitable manner. MPAC device 102 may include an MPAC circuit 104 configured to perform the implementations of the present disclosure for providing multiprotocol and adaptive charging. MPAC circuit 104 may be implemented in any suitable manner, such as by analog circuitry, digital circuitry, instructions on a machine-readable medium such as memory 128 for execution by a processor such as processor 126, an application specific integrated circuit, a field programmable gate array, or any suitable combination thereof. MPAC circuit 104 may be communicatively coupled to ports 110, 112, 114. MPAC circuit 104 may be communicatively coupled to a power supply 106 and may be configured to provide charging to USB elements attached to MPAC device 102 through power of power supply 106. Moreover, MPAC device 102 may include various other components 108, which may include any suitable components that may use or may be communicatively coupled to ports 110, 112, 114. For example, components 108 may include USB bridges, USB hubs, USB hosts, switch matrices, memory, or communication ports.

MPAC circuit 104 may be configured to detect connection or attachment of USB elements to any of ports 110, 112, 114, and, based upon the element connected or attached, adaptively provide charging to the respective port and thus the USB element.

If a USB Type A element—such as device 118—is plugged in to a USB Type A port—such as port 110—MPAC circuit 104 may be configured to may be configured to select a best available battery charging solution from available or known protocols.

If a USB Type C element—such as device 120—is plugged in to a USB Type C port—such as port 112—MPAC circuit 104 may be configured to provide PD through the USB-C protocol.

In one example, if a legacy device—such as a USB Type A device such as device 124—is connected to a USB Type C port—such as port 114 (through adapter 122)—and is not compliant with PD, then MPAC circuit 104 may be configured to may be configured to select a best available battery charging solution from available or known protocols. In a further example, this may be determined in a same manner as applied to determine a protocol when a USB Type A element—such as device 118—is plugged in to a Type A port—such as port 110, as discussed above.

When a USB element connects to a USB Type A port, such as port 110, MPAC circuit 104 may know that the element is a USB Type A element such as device 118, and may be configured to select a best available battery charging solution from available or known protocols to apply to the USB element. However, when a USB element connects to a USB Type C port, such as port 112 or port 114, in one example MPAC circuit 104 may be configured to evaluate whether to apply PD to the USB element (as a USB Type C element) or to treat the element as a USB Type A element and select a best available battery charging solution from available or known protocols to apply to the USB element.

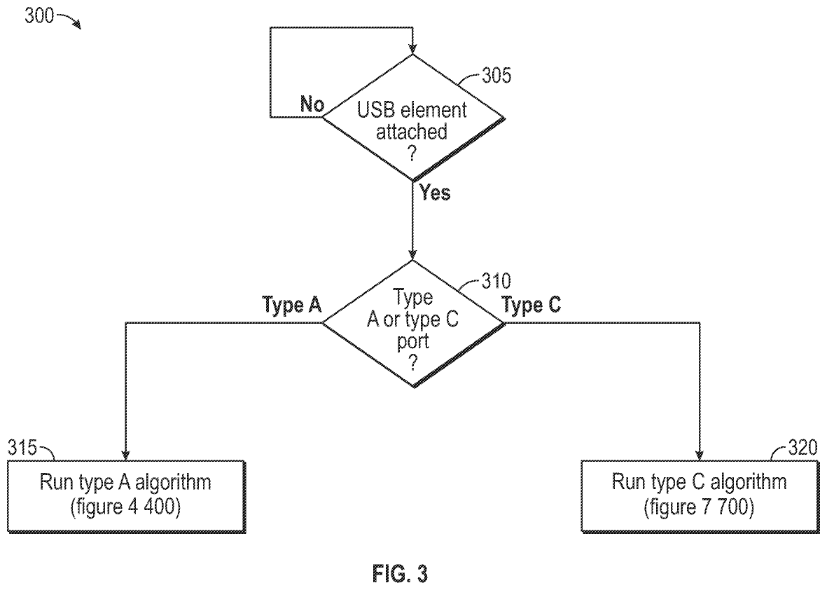

The operation of MPAC circuit 104 to determine whether an attached USB element has attached to a USB Type A or USB Type C port may be illustrated in FIG. 3, discussed in more detail below.

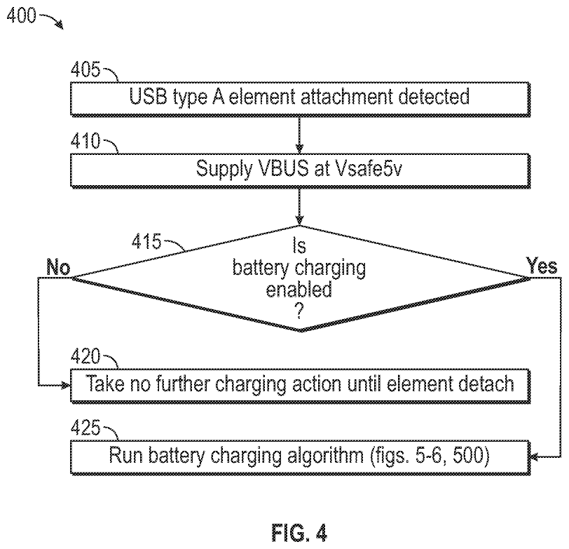

The operation of MPAC circuit 104 to evaluate the attachment of an element to a USB Type A port may be illustrated beginning in FIG. 4, discussed in more detail below.

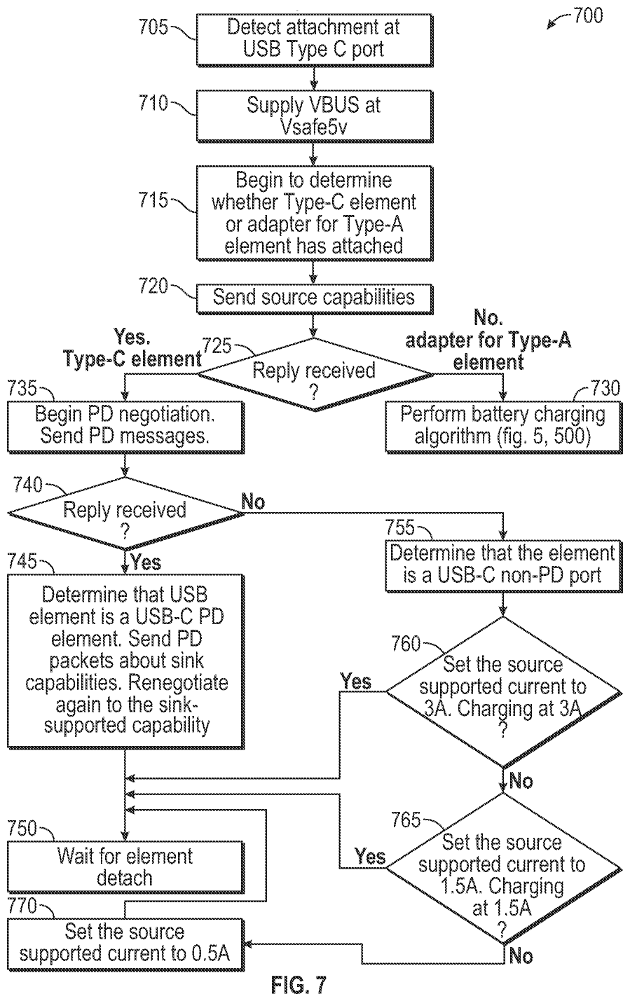

The operation of MPAC circuit 104 to evaluate the attachment of a USB element to a USB Type C port may be illustrated beginning in FIG. 7, discussed in more detail below.

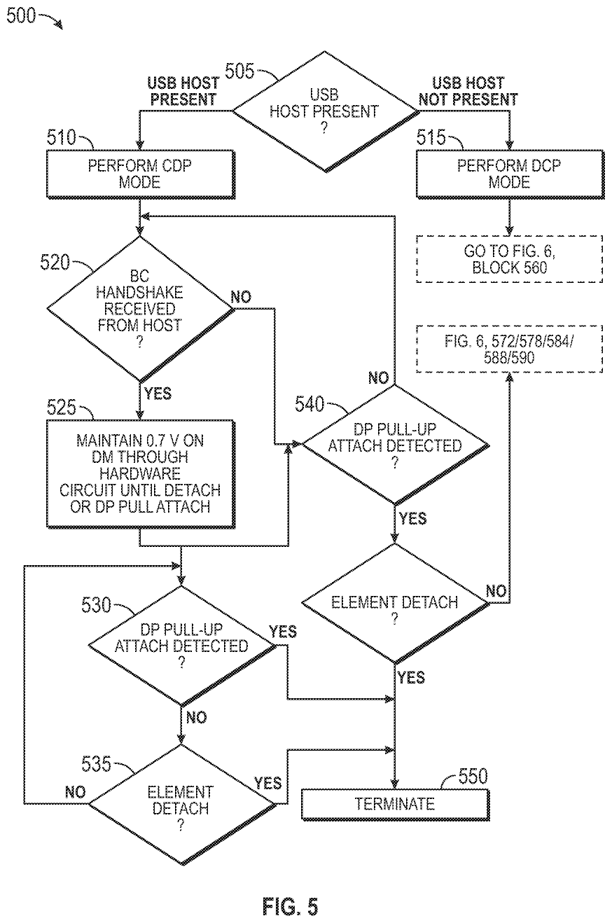

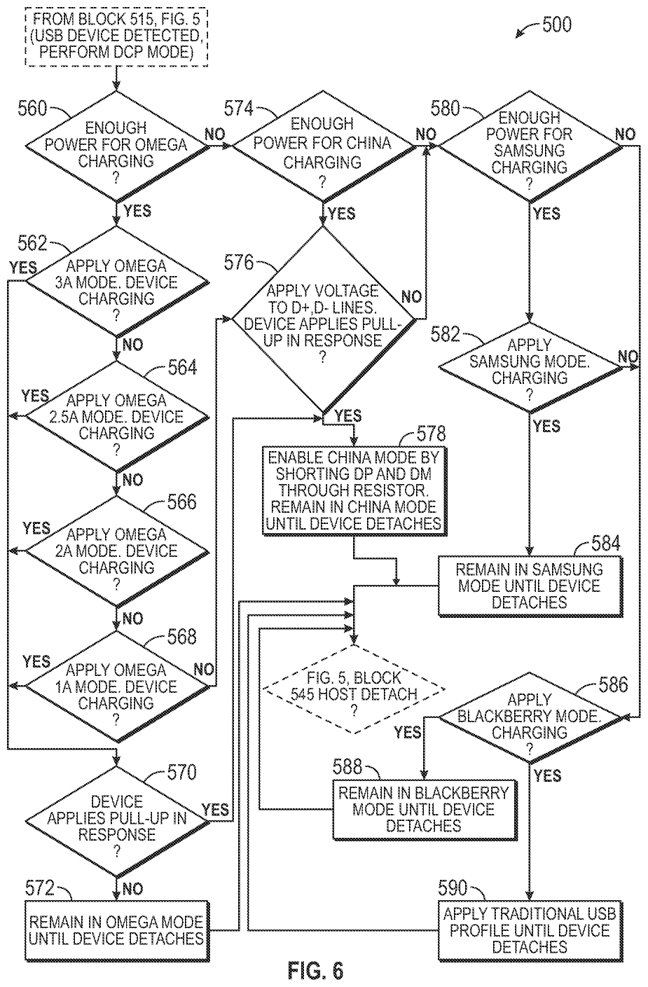

The operation of MPAC circuit 104 to select a best available battery charging solution from available or known protocols to apply to an attached USB element may be illustrated in FIGS. 5-6, discussed in more detail below. This operation may arise from, for example, attachment of a USB Type A device to a USB Type A port, or attachment of a USB Type A device to a USB Type C port through an adapter.

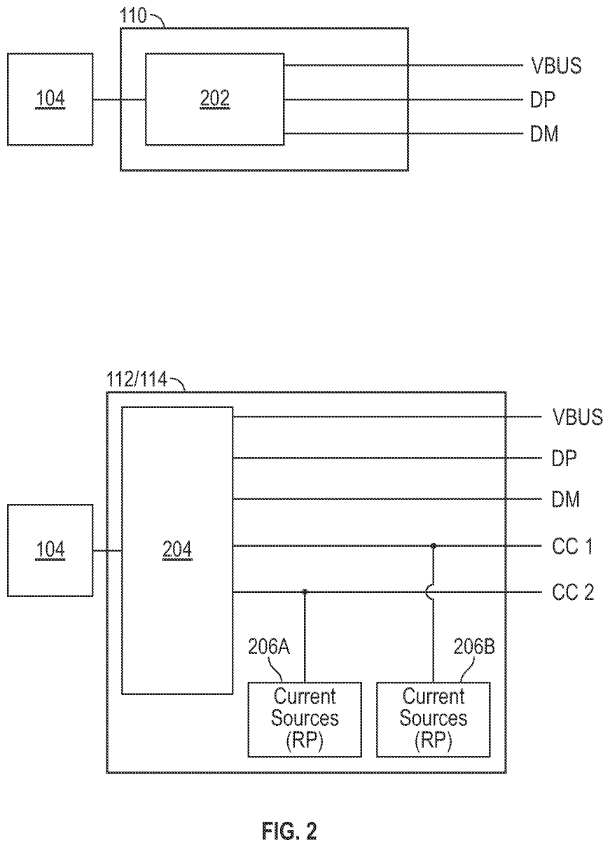

FIG. 2 is a more detailed illustration of ports 110, 112, 114, according to examples of the present disclosure.

Port 110 may include terminals for VBUS, DP (D+), and DM (D−) USB connections to a USB element connected thereto. Ports 112, 114 may also include terminals for VBUS, DP, and DM connections to a USB element connected thereto. Ports 112, 114 may include terminals for CC1 and CC2 connections to a USB element connected thereto.

Port 110 may include circuitry 202 configured to detect voltages or currents from its input pins, and thus, actions performed by devices connected thereto, such as application of pull-up resistors or handshakes. Circuitry 202 may be configured to selectively apply currents, voltages, pull-up resistors, and pull-down resistors to the input pins of port 110. These operations may be controlled by MPAC circuit 104. Moreover, these operations may be used to perform detection of specific USB charging modes and discussed in the present disclosure.

Similarly, ports 112, 114 may include circuitry 204 configured to detect voltages or currents from its input pins, and thus, actions performed by devices connected thereto, such as application of pull-up resistors or handshakes. Circuitry 204 may be configured to selectively apply currents, voltages, pull-up resistors, and pull-down resistors to the input pins of ports 112, 114. These operations may be controlled by MPAC circuit 104. Moreover, these operations may be used to perform detection of specific USB charging modes and discussed in the present disclosure. For example, various current sources 206, which may be defined according to voltage sources or pull up resistors, may be selectively applied to CC1 and CC2.

FIG. 3 is an illustration of an example method 300 for determining whether a USB element has attached to a USB Type A port or a USB Type C port, according to examples of the present disclosure. Method 300 may be performed by any suitable part of system 100, such as by MPAC circuit 104. Method 300 may include more or fewer blocks than those shown in FIG. 3. The blocks of method 300 may be optionally repeated, omitted, performed in parallel, performed recursively, or performed in a different order than shown.

At block 305, MPAC circuit 104 may determine whether any USB element has been attached to any of ports 110, 112, 114. If so, method 300 may proceed to block 310. Otherwise, MPAC circuit 104 may repeat block 305.

At block 310, MPAC circuit 104 may determine whether the USB element has attached to a USB Type A port or a USB Type C port. If the USB element has attached to a USB Type A port, method 300 may proceed to block 315, wherein MPAC circuit 104 may run a USB Type A algorithm. This may be illustrated in method 400 of FIG. 4, discussed in more detail below. If the USB element has attached to a USB Type C port, method 300 may proceed to block 320, wherein MPAC circuit 104 may run a USB Type C algorithm. This may be illustrated in method 700 of FIG. 7, discussed in more detail below.

FIG. 4 is an illustration of an example method 400 for determining how to power a USB element that has attached to a USB Type A port such as port 110, according to examples of the present disclosure. Method 400 may be performed by any suitable part of system 100, such as by MPAC circuit 104. Method 400 may include more or fewer blocks than those shown in FIG. 4. The blocks of method 400 may be optionally repeated, omitted, performed in parallel, performed recursively, or performed in a different order than shown.

At block 405, the attachment of a USB Type A element may be detected. The attachment may be made at, for example, port 110. At 410, at safe 5V supply signal may be applied to the VBUS line to the attached element.

At block 415, it may be determined, as a result of applying the 5V supply signal to VBUS, whether or not the attached element supports battery charging. This determination may be made by, for example, attempting to perform a battery charging (BC) handshake, and determining whether an appropriate response is received to the BC handshake. If the attached element does not support battery charging, method 400 may proceed to block 420. Otherwise, method 400 may proceed to block 425.

At block 420, no further action may be taken regarding battery charging until the USB element detaches.

At block 425, a battery charging algorithm may be performed. This may include method 500 of FIGS. 5-6, discussed in more detail below.

FIGS. 5-6 are an illustration of an example method 500 for selecting a best available battery charging solution from available or known protocols to apply to an attached USB element, according to examples of the present disclosure. Method 500 may be performed by any suitable part of system 100, such as by MPAC circuit 104. Method 500 may include more or fewer blocks than those shown in FIG. 4. The blocks of method 500 may be optionally repeated, omitted, performed in parallel, performed recursively, or performed in a different order than shown.

Method 500 may be performed based upon the attachment of a USB element to a USB Type A port, or an adapter to a USB Type C port. These may be reflected in, for example, block 425 discussed above, or in block 750 of FIG. 7, discussed further below.

At block 505, MPAC circuit 104 may determine whether the USB element that has attached to the port is a USB host or not. This may be determined in any suitable manner, such as by sensing the value of the VBUS. The particular voltage values of VBUS that indicate whether the USB element is a host or not may depend upon the particular implementation of USB employed in the system, but may be any voltage value that is accepted as a logical one value. For example, the voltage values carried on VBUS between USB elements may range from 3.3V to 20V. These voltages may in turn be stepped down or divided for evaluation by MPAC circuit 104. For example, if VBUS between USB elements ranges between 0V and 3.3V, with no voltage step-down, a voltage higher than 1.8V may be considered a logical one. In another example, if VBUS between USB elements ranges between 0V and 5V, a voltage above 4.5V may be considered a logical one. Furthermore, in such an example, there may be a 2:1 voltage divider for MPAC circuit 104 input, and thus any voltage above 2.25V observed by MPAC circuit 104 may be considered a logical one. If the USB element is a USB host, then method 500 may proceed to block 510. If the USB element is a USB device, then method 500 may proceed to block 515.

At block 510, a charging downstream port (CDP) mode may be utilized. Method 500 may proceed to block 520.

At block 515, a dedicated charging port (DCP) mode may be utilized. Method 500 may proceed to block 540.

At block 520, MPAC circuit 104 may determine whether BC handshake has been received from the element. The handshake may include, for example, whether an application of 0.7V on the D+ line is mirrored by application of 0.7 V on the D− line. If a BC handshake has been received, method 500 may proceed to block 525. Otherwise, method 500 may proceed to block 540.

At block 525, MPAC circuit 104 may respond to the BC handshake by keeping 0.7V on the DM line through the hardware circuit. This may be maintained until the host detaches, or until a DP pull attach is detected. Method 500 may proceed to block 530.

At block 530, MPAC circuit 104 may determine whether a DP pull-up attach operation has been detected. If so, method 500 may terminate at block 550. Otherwise, method 500 may proceed to block 535. At block 535, it may be determined whether the host has detached. Moreover, block 535 may be performed in parallel with any other block of method 500. The detachment monitoring may be performed by monitoring a DO line state in the hardware circuit. If the host has detached, method 500 may terminate at block 550. Otherwise, method 500 may return to block 530.

At block 540, MPAC circuit 104 may determine whether a DP pull-up attach has been detected. If so, method 500 may proceed to block 545 to wait for a host detach. Otherwise, method 500 may repeat at, for example, block 520. If a handshake is not received in block 520 in any of the iterations of method 500, then the host does not support standard USB charging protocols.

At block 545 MPAC circuit 104 may determine whether the USB element has detached. If the host has detached, method 500 may terminate at block 550. Otherwise, block 545 may repeat.

At block 560, MPAC circuit 104 may begin to determine which of several possible power charging protocols to use for the attached USB device. For example, MPAC circuit 104 may be configured to determine whether the attached USB device is to use Omega charging, China charging, custom charging, Samsung charging, or Blackberry charging. MPAC circuit 104 may be configured to iterate through two or more possible such protocols in any suitable order. In one example, MPAC circuit 104 may be configured to iterate through such protocols in an order corresponding to highest to lowest possible charging levels, so that a highest possible charging level is applied to the USB element. For example, if a given USB element is capable of multiple such charging protocols, by evaluating a charging protocol with a higher possible charging level first, the USB element may be charged with the higher possible charging level. Moreover, when evaluating a given protocol, MPAC circuit 104 may evaluate whether sufficient power is available to utilize the given protocol. This may be performed by referencing software configurations or other indications of power allocation within the system. For example, in system 100, the available power for USB ports 110, 112, 114 may be allocated or shared in any suitable manner, such as evenly between ports, prioritization of one port over another, or fair-share allocation scheme. Thus, the given USB port to which the USB element is attached and evaluated in method 500 may be allocated a given amount of power. This given amount of power may be checked by MPAC circuit 104 to determine whether a given protocol can be used in view of the allocated given amount of power.

In particular, at block 560, MPAC circuit 104 may determine whether sufficient power is available for Omega charging to be performed enabled. If so, method 500 may proceed to block 562. Otherwise, method 500 may proceed to block 574.

At block 562, MPAC circuit 104 may begin to enable Omega charging in 3.0, 2.5, 2.0, or 1.5 A mode through the hardware circuit and determining whether charging results. First, enabling Omega charging in the 3.0 A mode may be attempted. As a preliminary matter, MPAC circuit 104 may determine whether sufficient power is available for Omega charging in the 3.0 A mode. If so, Omega charging may be attempted by applying 3.3V on the D+ line and 2.7V on the D− line. MPAC circuit 104 may determine whether the USB element is charging as a result. If the USB element is charging as a result, method 600 may proceed to block 570. Otherwise, if the USB element is not charging as a result, or if insufficient power was available for Omega charging in the 3.0 A mode, method 600 may proceed to block 564.

At block 564, Omega charging in the 2.5 A mode may be attempted. As a preliminary matter, MPAC circuit 104 may determine whether sufficient power is available for Omega charging in the 2.5 A mode. If so, Omega charging may be attempted by applying 2.7V on the D+ line and 2.7V on the D− line. MPAC circuit 104 may determine whether the USB element is charging as a result. If the USB element is charging as a result, method 600 may proceed to block 570. Otherwise, if the USB element is not charging as a result, or if insufficient power was available for Omega charging in the 2.5 A mode, method 600 may proceed to block 566.

At block 566, Omega charging in the 2.0 A mode may be attempted. As a preliminary matter, MPAC circuit 104 may determine whether sufficient power is available for Omega charging in the 2.0 A mode. If so, Omega charging may be attempted by applying 2.7V on the D+ line and 2.7V on the D− line. MPAC circuit 104 may determine whether the USB element is charging as a result. If the USB element is charging as a result, method 600 may proceed to block 570. Otherwise, if the USB element is not charging as a result, or if insufficient power was available for Omega charging in the 2.0 A mode, method 600 may proceed to block 568.

At block 568, Omega charging in the 1.0 A mode may be attempted. As a preliminary matter, MPAC circuit 104 may determine whether sufficient power is available for Omega charging in the 1.0 A mode. If so, Omega charging may be attempted by applying 2.0V on the D+ line and 2.0V on the D− line. MPAC circuit 104 may determine whether the USB element is charging as a result. If the USB element is charging as a result, method 600 may proceed to block 570. Otherwise, if the USB element is not charging as a result, or if insufficient power was available for Omega charging in the 1.0 A mode, method 600 may proceed to block 576.

At block 570, MPAC circuit 104 may determine whether the USB element has applied a pull-up resistor in response to the attempted Omega charging. If so, method 700 may proceed to block 585 to apply China mode. Otherwise, method 500 may proceed to block 572.

At block 572, MPAC circuit 104 may maintain charging of the USB device in a determined Omega mode. MPAC circuit 104 may wait for the USB device to detach by, for example, returning to block 545.

At block 574, MPAC circuit 104 may determine whether sufficient power is available to perform China charging. This may be performed by checking software configurations. If so, method 500 may proceed to block 576. Otherwise, method 500 may proceed to 580.

At block 576, a China charging mode may be validated by applying voltages to the D+, D− USB lines. The voltages may include, for example, any of the Omega voltage levels described in blocks 562, 564, 566, or 568. After applying the voltages, MPAC circuit 104 may determine whether the attached element has applied a pull-up resistor in response to the application of voltages. This may be determined by evaluating an amount of current drawn by the USB element. For example, if a pull-up resistor has been applied, method 500 may proceed to block 578. Otherwise, method 500 may proceed to block 580.

At block 578, China charging mode may be enabled by MPAC circuit 104 by shorting the D+ and D− lines through a resistor. MPAC circuit 104 may maintain charging of the USB device in the China charging mode. MPAC circuit 104 may wait for the USB device to detach by, for example, returning to block 545.

At block 580, it may be determined whether sufficient power is available to perform Samsung charging. This may be performed by checking software configurations. If so, method 500 may proceed to block 582. Otherwise, method 500 may proceed to block 586.

At block 582, a Samsung mode may be applied. A voltage of 1.1V may be applied to both D+ and D− lines. It may be determined whether charging has begun. This may be determined identifying that the USB element has drawn more than 500 mA. If so, method 500 may proceed to block 584. Otherwise, method 500 may proceed to block 586.

At block 584, MPAC circuit 104 may maintain charging of the USB device in the Samsung mode. MPAC circuit 104 may wait for the USB device to detach by, for example, returning to block 545.

At block 586, a Blackberry mode may be applied. It may be determined whether charging has begun. If so, method 500 may proceed to block 588. Otherwise, method 500 may proceed to block 590.

At block 588, MPAC circuit 104 may maintain charging of the USB device in the Blackberry mode. MPAC circuit 104 may wait for the USB device to detach by, for example, returning to block 545.

At block 590, MPAC circuit 104 may maintain charging of the USB device in a traditional USB profile charging mode, such as battery charging 1.2. MPAC circuit 104 may wait for the USB device to detach by, for example, returning to block 545.

FIG. 7 is an illustration of an example method 700 for determining how to power a USB element that has attached to a USB Type C port such as ports 112 or 114, according to examples of the present disclosure. Method 700 may be performed by any suitable part of system 100, such as by MPAC circuit 104. Method 700 may include more or fewer blocks than those shown in FIG. 4. The blocks of method 700 may be optionally repeated, omitted, performed in parallel, performed recursively, or performed in a different order than shown.

At block 705, MPAC circuit 104 may be configured to determine that a USB element has attached to a USB Type C port such as port 112 or port 114. MPAC circuit 104 may be configured to determine the nature of the USB element that has been attached to port 112 or port 114.

For example, at block 710, MPAC circuit 104 may be configured to apply the voltage of the USB bus, VBUS, to the respective port 112 or port 114.

At block 715, MPAC circuit 104 may be configured to begin to determine whether the attached USB element is connected through an adapter (such as USB element 124 connected through adapter 122), or the attached USB element is a USB Type C host or device connected directly to port 112. MPAC circuit 104 may be configured to make this determination in any suitable manner.

For example, at block 720, MPAC circuit 104 may be configured to send source capabilities messages to the element that has attached to the port. From this, MPAC circuit 104 may be configured to determine whether the attached USB element is a USB Type C host or device connected directly to the port, or that the attached USB element is a USB Type A element connected through a USB Type C adapter.

At block 725, MPAC circuit 104 may determine whether a reply has been received to the message with the source capabilities. If a message has been received, then the attached USB element may be a USB Type C host or device connected directly to the port. This may occur in FIG. 1 in, for example, port 112 with the attachment of device 120. Method 700 may proceed to block 735. If no message has been received, then the attached USB element may be a USB Type A element connected through a USB Type C adapter. This may occur in FIG. 1 in, for example, port 114 with the attachment of device 124 through adapter 122. Method 700 may proceed to block 730.

At block 730, MPAC circuit 104 may perform a battery charging algorithm. This may be performed, for example, by method 500 in FIG. 5, discussed above.

At block 735, any suitable PD negotiation may begin to be performed with the attached USB element. For example, MPAC circuit 104 may send PD capability messages to the attached USB element. The PD capability messages may, for example, determine whether the attached USB element supports programmable power supplies. Such programmable power supplies may enable charging techniques that do not otherwise follow the USB specification and may include, for example, fast charging.

At block 740, MPAC circuit 104 may determine whether a reply to the PD capability messages has been received. If so, method 700 may proceed to block 745. Otherwise, method 700 may proceed to block 755.

At block 745, MPAC circuit 104 may determine that the USB element is a USB-C element with PD capabilities. MPAC circuit 104 may send PD packets to the USB element about sink capabilities. MPAC circuit 104 may further negotiate with the USB element to the sink-supported capabilities of the connection to the USB element. This may be performed, for example, through enablement of programmable power supplies may be enabled, and resending source capabilities to the attached device to further negotiate a best available power level of charging. Method 700 may proceed to block 750.

At block 750, MPAC circuit 104 may wait for the device to detach.

At block 755, MPAC circuit 104 may determine that the USB element is a USB-C element without PD capabilities. MPAC circuit 104 may begin to determine a most appropriate charging level for the USB element. This is described in more detail in blocks 760, 765, and 770. Blocks 760, 765, 770 may be performed by, for example, applying different RP resistor values to CC lines connected to the element to evaluate the current received across the VBUS.

At 760, MPAC circuit 104 may set a source of supported current to the USB element to be 3 A. MPAC circuit 104 may then determine whether the USB element is charging. If so, method 700 may proceed to block 750. Otherwise, method 700 may proceed to block 765.

At 765, MPAC circuit 104 may set a source of supported current to the USB element to be 1.5 A. MPAC circuit 104 may then determine whether the USB element is charging. If so, method 700 may proceed to block 750. Otherwise, method 700 may proceed to block 770.

At block 770, MPAC circuit 104 may set a source of supported current to the USB element to be 0.5 A. Method 700 may proceed to block 750.

Although examples have been described above, other variations and examples may be made from this disclosure without departing from the spirit and scope of these examples.

What is claimed is:

1. An apparatus, comprising:
a universal serial bus (USB) type C port; and
a multi-protocol adaptive circuit configured to:
determine that a USB element has attached to the USB type C port; and
determine whether to apply a USB type C charging protocol to the USB element or a legacy USB type A charging protocol to the USB element.

2. The apparatus of claim 1, wherein, in order to determine whether to apply a USB type C charging protocol or a legacy USB type A charging protocol to the USB element, the multi-protocol adaptive circuit is further configured to:
send source capabilities to the USB element;
evaluate a reaction of the USB element in response to the sent source capabilities; and
determine whether to apply a USB type C charging protocol or a legacy USB type A charging protocol to the USB element based upon the reaction.

3. The apparatus of claim 2, wherein the multi-protocol adaptive circuit is further configured to determine to apply a legacy USB type A charging protocol to the USB element based upon the reaction of the USB element, the reaction to include no reply.

4. The apparatus of claim 1, wherein the multi-protocol adaptive circuit is further configured to determine that the USB element is a USB type A element connected through an adapter to the USB type C port.

5. The apparatus of claim 4, wherein the multi-protocol adaptive circuit is further configured to apply a legacy USB type A charging protocol to the USB element based upon the determination that the USB element is a USB type A element connected through the adapter to the adapter to the USB type C port.

6. The apparatus of claim 1, wherein upon a determination that a legacy USB type A charging protocol is to be applied to the USB element, the multi-protocol adaptive circuit is further configured to apply a series of a plurality of candidate legacy USB type A charging protocols to the USB element to determine a best protocol among the candidate legacy USB type A charging protocols to be used by the USB element.

7. The apparatus of claim 6, wherein the multi-protocol adaptive circuit is configured to:
apply the series of candidate legacy USB type A charging protocols through, for each candidate legacy USB type A charging protocol, application of test voltages to a D+ line and a D− line connected between the USB type C port and the USB element, the test voltages associated with the candidate legacy USB type A charging protocol, the series of candidate legacy USB type A charging protocols ordered according to charging power; and
based upon a determination that the USB element has applied a pull-up resistor in response to the test voltages, determine that a China mode legacy USB type A charging protocol is be used by the USB element.

8. A method, comprising:
determining that a USB element has attached to a universal serial bus (USB) type C port; and
determining whether to apply a USB type C charging protocol to the USB element or a legacy USB type A charging protocol to the USB element.

9. The method of claim 8, wherein determining whether to apply a USB type C charging protocol or a legacy USB type A charging protocol to the USB element includes:
sending source capabilities to the USB element;
evaluating a reaction of the USB element in response to the sent source capabilities; and
determining whether to apply a USB type C charging protocol or a legacy USB type A charging protocol to the USB element based upon the reaction.

10. The method of claim 9, further comprising determining to apply a legacy USB type A charging protocol to the USB element based upon the reaction of the USB element, the reaction to include no reply.

11. The method of claim 8, further comprising determining that the USB element is a USB type A element connected through an adapter to the USB type C port.

12. The method of claim 11, further comprising applying a legacy USB type A charging protocol to the USB element based upon the determination that the USB element is a USB type A element connected through the adapter to the adapter to the USB type C port.

13. The method of claim 8, further comprising, upon a determination that a legacy USB type A charging protocol is to be applied to the USB element, applying a series of a plurality of candidate legacy USB type A charging protocols to the USB element to determine a best protocol among the candidate legacy USB type A charging protocols to be used by the USB element.

14. The method of claim 13, further comprising:
applying the series of candidate legacy USB type A charging protocols through, for each candidate legacy USB type A charging protocol, application of test voltages to a D+ line and a D− line connected between the USB type C port and the USB element, the test voltages associated with the candidate legacy USB type A charging protocol, the series of candidate legacy USB type A charging protocols ordered according to charging power; and
based upon a determination that the USB element has applied a pull-up resistor in response to the test voltages, determining that a China mode legacy USB type A charging protocol is be used by the USB element.

15. A system, comprising:
a power source;
a universal serial bus (USB) type C port;
a multi-protocol adaptive circuit configured to:
determine that a USB element has attached to the USB type C port;
determine whether to apply a USB type C charging protocol to the USB element or a legacy USB type A charging protocol to the USB element; and
cause power to be provided from the power source to the USB element using a selected charging protocol.

16. The system of claim 15, wherein, in order to determine whether to apply a USB type C charging protocol or a legacy USB type A charging protocol to the USB element, the multi-protocol adaptive circuit is further configured to:
send source capabilities to the USB element;
evaluate a reaction of the USB element in response to the sent source capabilities; and
determine whether to apply a USB type C charging protocol or a legacy USB type A charging protocol to the USB element based upon the reaction.

17. The system of claim 16, wherein the multi-protocol adaptive circuit is further configured to determine to apply a legacy USB type A charging protocol to the USB element based upon the reaction of the USB element, the reaction to include no reply.

18. The system of claim 15, wherein the multi-protocol adaptive circuit is further configured to determine that the USB element is a USB type A element connected through an adapter to the USB type C port.

19. The system of claim 18, wherein the multi-protocol adaptive circuit is further configured to apply a legacy USB type A charging protocol to the USB element based upon the determination that the USB element is a USB type A element connected through the adapter to the adapter to the USB type C port.

20. The system of claim 15, wherein upon a determination that a legacy USB type A charging protocol is to be applied to the USB element, the multi-protocol adaptive circuit is further configured to apply a series of a plurality of candidate legacy USB type A charging protocols to the USB element to determine a best protocol among the candidate legacy USB type A charging protocols to be used by the USB element.
